(19) United States
(12) Patent Application Publication
(10) Pub. No.: US 2013/0056412 A1
(43) Pub. Date: Mar. 7, 2013

(54) MIXED LIQUOR FILTERABILITY TREATMENT IN A MEMBRANE BIOREACTOR

(71) Applicants: Sheng Chang, Oakville (CA); Sijing Wang, Shanghai (CN); Boris Fernandez Ginzburg, Oakville (CA); Fengshen Fan, Guelph (CA)

(72) Inventors: Sheng Chang, Oakville (CA); Sijing Wang, Shanghai (CN); Boris Fernandez Ginzburg, Oakville (CA); Fengshen Fan, Guelph (CA)

(21) Appl. No.: 12/810,024

(22) PCT Filed: May 5, 2010
(86) PCT No.: PCT/CN2010/000620

§ 371 Date: Jun. 22, 2010

(51) Int. Cl. C02F 3/00

(52) U.S. Cl. 210/631; 210/198.1

(57) ABSTRACT

A membrane bioreactor uses a process and apparatus for dosing flux enhancing chemicals (FEC) to respond to temporary periods of operation that cause, or are likely to cause, membrane fouling. An FEC dosing device is provided in communication with a channel separating a process tank and the membrane unit of an MBR. A mixer in the channel rapidly mixes dosed FEC with mixed liquor flowing into the membrane tank. The dosing device is connected to sensors sensing conditions in the channel, the membrane unit or both. FEC is added to the mixed liquor flowing into the membrane unit considering conditions in the mixed liquor flowing to the membrane unit or membrane operating parameters or both. The FEC dosage may be in the range of 0.05 to 10 mg/g MLSS. The process may include steps of initiating dosing, adjusting the dosing concentration, and terminating dosing.

### FIELD

This specification relates to the control of membrane bioreactors and to the use of chemical filterability enhancers to treat mixed liquor in a membrane bioreactor.

### BACKGROUND

The following is not an admission that any information described below is citable as prior art or common general knowledge.

A membrane bioreactor (MBR) combines membrane filtration with a biological process to treat wastewater. In general, one or more biological process tanks are integrated with a membrane filter by placing the membrane filter in one of the tanks or in a recirculation loop connected to the process tank or tanks. For example, a membrane filter can be used in place of a clarifier in an activated sludge process. Treated effluent (often called permeate) is filtered and withdrawn through the membranes. Retained sludge is either recirculated from the membrane tank back to a process tank if the membrane filter is located in a separate tank, or simply left in a process tank if the membrane filter is immersed directly into the process tank. Because the membrane filter does not operate in all ways like a clarifier, various process changes are possible or required. For example, since the membrane filter does not require the biomass to settle out of the mixed liquor, the mixed liquor suspended solids concentration (MLSS) may be increased relative to a process that uses a clarifier. However, the mixed liquor fouls the pores of the membranes over time and managing membrane fouling remains a primary concern in the operating an MBR.

The primary consideration in managing membrane fouling is the flux (rate of flow of water per unit of membrane surface area) that the membrane units must handle. Subject to temporary small changes in other process parameters, flux is generally proportional to the feed flow rate divided by the membrane surface area. Increases in flux generally increase fouling, and fouling may increase rapidly above a critical flux of the MBR.

Another consideration is the tendency for the mixed liquor to cause fouling, sometimes called its filterability or fouling index. Filterability is related to various factors such as the mixed liquor suspended solids concentration (MLSS) and temperature. However, filterability can be increased by adding a flux-enhancing chemical (FEC) into the feed water or process tanks. As described in U.S. Pat. No. 6,926,832, various polymeric FECs may be mixed with the mixed liquor by adding an initial concentration of about 25 to 100 ppm based on the mixed liquor volume of the MBR. Additional polymer is then added to find an effective concentration that increases filterability while monitoring permeate total organic carbon (TOC), chemical oxygen demand (COD) or biological oxygen demand (BOD) to ensure that the polymer stays below a concentration that would impede biological activity in the mixed liquor. In practice, effective concentrations of most FECs range from 200 to 800 ppm. For example, Yoon et al. (Desalination 191 (2006) 52-61) describe the use of MPE50, a cationic polymeric FEC from Nalco, at 200 ppm. After establishing the effective concentration, maintenance doses of FEC are required to make up for losses of FEC due to chemical reactions or with the removal of waste actuated sludge. For large plants in particular, such as a municipal wastewater treatment plant, the FEC adds a significant cost to the annual operating expense.

Other methods to manage fouling involve processes directed at the membrane unit. Such methods include relaxation (temporary removal of transmembrane pressure), membrane backwashing, bubble scouring and chemical cleaning. These methods all have disadvantages such as disturbing the filtration process (relaxation, backwashing, chemical cleaning) or consuming energy (bubble scouring).

With many MBRs, such as municipal wastewater treatment plants, fouling control is complicated by variations in flux and filterability over time. For example, an MBR may receive a daily peak feed flow that exceeds the average flow by a significant factor. Seasonal temperature variations also cause variations in filterability. Accordingly, an MBR in operation encounters a range of expected fouling conditions.

Sufficient membrane area to handle expected peak flows is generally made available, although this results in an excess of membrane area during off-peak times. Since the membranes have a significant cost roughly proportional to their surface area, selecting a membrane area for expected peak flows increases cost. The MBR may also encounter unusual conditions from time to time. For example, a high peak flow on a very cold day could cause an unexpected increase in fouling. As a result, many MBRs become unstable from time to time.

US Patent Application Publication 2007/0039888 A1 describes a process in which one or more factors in the operation of a membrane unit may be changed considering measurements of the resistance of the membranes while the membranes are in operation. For each factor, there are at least two discrete states of operation, one of which provides increased control of fouling, the other being more economical. If resistance exceeds a threshold value, one or more factors are switched to the more fouling resistant state of operation. The primary example is a change in aeration frequency factor, particularly a change from providing bubble scouring for 10 seconds out of every 40 seconds, to providing bubbles scouring for 10 seconds out of every 20 seconds. The use of FECs is listed in a hierarchy of factors that might be changed in response to membrane resistance. If resistance exceeds a high limit set point, and other changes in the hierarchy have already been made (switch from relation to backpulse, increase backpulse flow rate, turn on standby membrane trains, increase air flow rate, increase aeration frequency factor) then an activated sludge filterability enhancer can be added. If resistance drops below a low limit set point, and aeration frequency factor has already been reduced from its maximum available value, then the addition of activated sludge filterability enhancer can be stopped. Although this may be effective, a large amount of FEC is consumed, similarly large storage and dosing equipment is required, and the chemicals can sometimes negatively effect the operation of the bioreactor or its effluent quality.

### INTRODUCTION

This section is intended to introduce the reader to the detailed description to follow and not to limit or define any claim.

The method and apparatus to be described in more detail further below provide a new way to use FECs to address temporary fouling conditions in an MBR. The effect of the FEC can be made quick enough to respond to high fouling or low filterability conditions that are present for short time periods, for example 2 hours to 2 or 3 days while consuming only a small amount of FEC. Short duration stressful conditions may be caused, for example, by sudden loading changes or cold water peaking events such as snow melt or winter rain. With additional means to counter unusual temporary fouling conditions, membrane surface area can be reduced in a plant of a given capacity, or the ability of a plant to operate stably during difficult conditions may be enhanced.

In the apparatus, an FEC dosing device is provided in communication with a channel separating a process tank and the membrane system of an MBR. A mixer in the channel rapidly mixes dosed FEC with mixed liquor flowing into the membrane tank. The dosing device is connected to sensors sensing conditions in the channel, the membrane system or both. The apparatus allows FEC to be dosed into the mixed liquor flowing into the membrane system, rather than into the plant feed or process tanks, in response to conditions in the mixed liquor or the membrane system.

In the process, FEC is added to the mixed liquor flowing into the membrane system considering conditions in the mixed liquor flowing to the membrane system . or membrane operation parameters or both. The FEC dosage may be in the range of 0.05 to 10, or 0.5 to 5, mg per gram of solids flowing with the mixed liquor to the membrane system. The process may include steps of initiating dosing, optionally adjusting the dosing concentration, and terminating dosing. The dosing time may be in the range of 30 minutes to 8 hours or 30 minutes to 3 hours. The effect of the dose persists for about 2 to 10 times the dosing time.

With mixing into the mixed liquor flowing into the membrane filtration system, the FEC can produce an immediate reduction in membrane filtration resistance even at very low instantaneous concentrations relative to the MBR system mixed liquor volume. The operation of the membrane system can thus be stabilized during periods that would otherwise cause increased membrane fouling, while using a dosing system having a small dosing capacity and reduced chemical consumption relative to systems aimed at conditioning the mixed liquor of the entire MBR system.

### DRAWINGS

FIG. 1 is a schematic representation of an MBR with a chemical dosing system.

### DETAILED DESCRIPTION

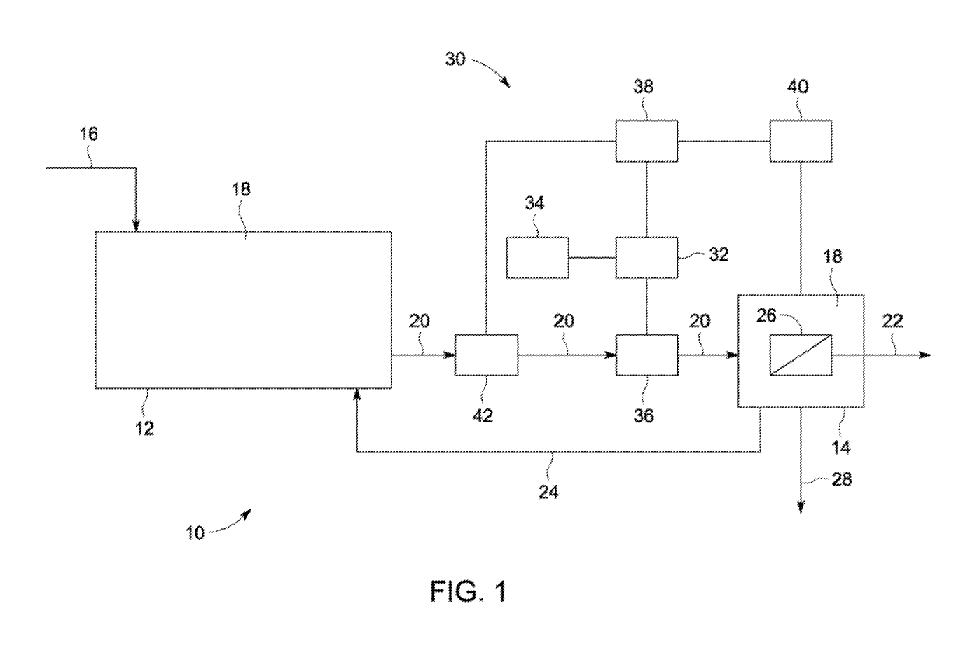

FIG. 1 shows an MBR 10 having one or more process tanks 12 and a membrane filtration system 14. Plant (raw) feed 16 enters the process tank 12 and mixes with mixed liquor 18. Recirculating mixed liquor 18 flows through a channel 20 to the membrane filtration system 14. Channel 20 may be an open channel, or a closed channel such as a pipe. In a large MBR, channel 20 may be an open flow distribution channel that receives the outlet from two or more parallel process tanks and feeds into the inlets of two or more parallel membrane tanks. Membrane filtration system 14 may be an immersed membrane system, with a membrane filtration unit 26 immersed in an open tank and permeate withdrawn by suction. Alternately, the membrane filtration system may have a membrane filtration unit 26 in a closed vessel with permeate removed by pressurizing the mixed liquor and operating in a cross-flow process, or a dead end process with periodic backwashing and deconcentration steps. Retentate from the membrane system 14 is returned to the process tank 12 through a return line 24. Permeate is withdrawn through a permeate header 22. Waste activated sludge is removed as required through a drain 28.

A chemical dosing system 30 is connected to the membrane filtration system 14 and the channel 20. The chemical dosing system has a dosing device 32 connected to a chemical storage tank 34. The dosing device 32 may be an analog or digital controllable dosing pump with a manual or automatic calibration device. The chemical storage tank 34 holds the flux-enhancing chemicals (FEC). The dosing device 32 draws FEC from the storage tank 34 and pumps it into the channel 20. The FEC enters the channel 20 upstream of or through a mixer 36 in the channel. Mixer 36 mixes incoming FEC with mixed liquor flowing in the channel. The mixer 36 may be, for example, a static in-line mixer that contains elements bringing about a sudden change in flow pattern in the channel 20 or a powered in-line mixer containing a moving mixing element. Mixing the FEC directly into the channel 20 allows for nearly instantaneous flow-through treatment of the mixed liquor 18 flowing to the membrane filtration unit 14. Alternatively, a membrane tank might be designed to allow mixing of the FEC into the mixed liquor as it flows into the membrane tank.

FECs may be, for example, polymers or inorganic coagulants such as metal salts (Water Research, 43 (2009):822-830). Various polymeric FECs are described in U.S. Pat. Nos. 6,723,245, 6,872,312, 6,926,832, 7,378,023 and 7,611,632 and US Publication Nos. 2004/0168980 and 2006/0272198. Examples of polymeric FECs include polymers of (meth)acrylamide and one or more cationic monomers, cationic polymers, copolymers of acrylamide and one or more cationic monomers, polyamine coagulants, polyDADMAC, polyMETAC, co-polymers of AETAC and acrylamide, and tannin containing polymers. Commercial FECs include cationic polymeric FECs such as MPE50 made by Nalco Corporation or Naperville, Ill., USA and Ciba Zetag 7631. Useful inorganic coagulants may be selected from the group of inorganic salts or their polymerized forms containing Ca, Mg, Al, Fe, or combinations thereof, such as FeCl₃, alum and poly aluminum chloride.

The chemical dosing system 30 also includes control elements including a dosing device controller 38. Controller 38 is connected to one or more membrane operation sensors 40, one or more process sensors 42, or both. Controller 38 operates dosing device 32 considering the signals received from one or more of the sensors 40, 42. For example, controller 38 may be a programmable logic controller configured to operate according to a process as will be described below. Membrane operation sensors 40 may measure, for example, one or more of the trans-membrane pressure (TMP) and permeate flow rate. Often one of TMP and permeate flow rate is fixed in the membrane filter control strategy and the other is variable and can be used as a sensed variable for the chemical dosing system 30. The process sensors 42 may measure, for example, one or more of the mixed liquor flow rate in the channel 20 and physical or chemical properties of the mixed liquor in the channel 20 such as temperature, dissolved oxygen content, and MLSS concentration. Although it is preferable to sense these properties in the channel 20, sensors in the process tank 12 may also be used for to measure physical or chemical properties of the mixed liquor if the values in the channel 20 are likely to be similar. The controller 38 may also be connected to or incorporate a timer or a counter to calculate derived examples, for example to calculate mixed liquor filterability or a change in resistance over time or between backwashing processes based on TMP and permeate flow rate information.

A sample control process has three basic steps of starting a dosing action, adjusting the dosing rate, and terminating the dosing action. The start of a dosing action can be triggered when one or more of the sensed parameters reaches a predetermined set point. The controller 38 polls one or more sensors 40, 42 at regular time intervals and compares a retrieved value with a set point stored in memory in the controller 38. When the retrieved value exceeds the set point, a dosing sub-routine is initiated.

Parameters that are useful to consider in starting a dosing action include the flow rate of mixed liquor flowing to the membrane system 14, the temperature of the mixed liquor flowing to the membrane system, the dissolved oxygen content of the mixed liquor flowing to the membrane system, the TMP (or permeate flow if TMP is fixed), filtration resistance, rate of change of TMP or resistance, and filterability. Optionally, a combination of two or more parameters may be considered. If permeation is continuous, a rate of change of TMP or resistance can be determined by comparing values separated by a predetermined time interval. If permeation is intermittent, interrupted by periods of backwashing or relaxation, a rate of change of TMP or resistance can be determined by measuring an increase within a permeation cycle (comparing values near the start and end of a permeation period), comparing values taken at the same point in different permeation periods, or comparing increases within cycles between different permeation periods. A useful measure related to filterability is cake plus pore blocking resistance (Rb+Rc) accumulated over a permeation cycle, which can be calculated by subtracting the resistance during a backwash from the resistance before a back wash.

The rate of chemical addition during dosing is determined based on the flow-through solids content rather than the total MLSS in the bioreactor system and or the incoming raw water feed flow, and may be in the range of 0.05 to 10 mg per gram of mixed liquor solids flowing to the membrane system. The instantaneous dosing concentration in mg FEC per gram of dry MLSS is calculated by multiplying the FEC solution dosing rate by the FEC concentration in the solution, and dividing that by the product of the mixed liquor flow rate to the membrane tanks and the MLSS concentration.

Chemical dosing may be initiated at a predetermined minimum dosing rate, for example 1 mg per gram of suspended solids in the mixed liquor flowing to the membrane system 14. Chemical dosing may be continuous or intermittent within a dosing period. After initiation, the dosing rate may be increased in discrete increments, for example of 1 mg per gram of suspended solids in the mixed liquor flowing to the membrane system 14, after a predetermined time period or at the start of a permeation cycle. The dosing rate may be increased until the TMP or resistance increase in a cycle, or the TMP or resistance increase over a selected period of time, are below a pre-determined set point. The dosing continues until a predetermined period of time has elapsed from the start of the dosing operation or for as long as the set point that triggered the start of the dosing period remains above its set point. The FEC is used to minimize the effect on resistance of changed process conditions and stabilize the operation of the membrane filtration process. US Patent Application Publication 2007/0039888 A1 to Ginzburg et al., published on Feb. 22, 2007, is incorporated herein in its entirety by this reference to it. The control strategies and measurement techniques described therein may be adapted to or combined with the methods described in this document.

### EXAMPLES

A pilot system used for testing had an aeration tank and a membrane tank. The aeration tank had a volume of 14 cubic meters. The membrane tank had a volume of 0.97 cubic meters. The membrane tank included 3 ZeeWeed 500 D membrane modules, each with a membrane surface area of about 370 square feet. The membranes were aerated with two aerators receiving a total air flow of 20 cfm switched from one aerator to the other every 10 seconds. Permeation was performed in a cycle of 12 minutes of permeation followed by 30 seconds of relaxation. Sludge was pumped from the aeration tank at a rate of 5 times the feed flow rate of 38 to 88 L/min, the excess sludge returning to aeration tank by overflowing a weir. During the tests, TCOD ranged from 360-445 mg/L; TN ranged from 32-40 mg/L; TSS ranged from 174 to 296 mg/L and pH ranged from 5.74 to 7.82 in the feed water. Total MLSS in the system was 140 to 150 kg. F/M (TCOD, MLSS based) was 0.18 to 0.4 kg TCOD/(kg MLSS.day).

In various tests, the membrane flux was set at a high value for the water temperature to create conditions under which the membranes would normally foul rapidly. A tannin containing polymer as described in U.S. Pat. No. 7,611,632, which is incorporated herein by this reference to it, was used as an FEC. In particular, the FEC was a polymeric aqueous product containing about 38 weight % of a copolymer of tannin and AETAC. (N,N-Dimethylaminoethyl Acrylate Methyl Chloride) having a molecular weight of about 75,000. The FEC was mixed into a pipe delivering mixed liquor from the aeration tank to the membrane tank. All TMP values in the examples below are measured before backwash.

In one test, the mixed liquor had a temperature of 12.3° C. Operation at a fixed flux of 14 gfd produced generally stable operation at a TMP of about 1.2 psi. The flux was increased and maintained to 24 gfd. This caused TMP to immediately rise to about 2.2 psi and to increase to about 2.4 psi over the next hour of operation. Dosing of the FEC was then started and continued for about 150 minutes at 0.32 mg/g MLSS. During this time, operation was generally stable at a TMP of about 2.4 psi rising slowly to about 2.5 psi. The dosing rate was then increased to 1.5 mg/g for 160 minutes. A total of 2.92 mg of FEC had been added per gram of MLSS in the system. The TMP immediately reduced to about 2.3 psi and further declined to about 2.1 psi at the end of the dosing period.

In another test, the mixed liquor had a temperature of 15.2 to 17.5° C. and flux was held constant at 30 gfd. In the absence of FEC, TMP was about 2.7 psi trending upwards in time. The FEC was dosed at 0.38 mg/g MLSS and for 50 minutes and caused an immediate reduction in TMP to 2.5 psi trending downwards in time. Increasing the dose to 0.75 mg/g MLSS for another 50 minutes reduced TMP to about 2.2 by the end of that period. A further increase in the dose to 1.65 mg/g MLSS for 40 minutes reduced TMP to near 2.0 psi. A total of 2.85 mg of FEC had been added per gram of MLSS in the system. After FEC dosing stopped, TMP increased to about 2.2 over the next 100 minutes at which time the trial stopped.

In another test, the mixed liquor had a temperature of 15.1 to 17.7° C. and flux was held constant at 35 gfd. Without any FEC added, TMP reached 10 psi in under 20 minutes and the test had to be temporarily shut down. Testing was resumed with the addition of FEC at 0.23 mg/g MLSS for 30 minutes, during which time TMP was between about 3.5 and 4.5 psi, trending upwards in time. Dosing rate was increased to 0.51 mg/g .MLSS for 40 minutes during which time TMP was between 4.5 and 3.5 psi, trending downwards in time. A further increase in dosing rate to 1.17 mg/g for the next 30 minutes produced a TMP of about 3 psi at the end of the dosing period. A total of 2.9 mg of FEC had been added per gram of MLSS in the system. Chemical dosing was stopped and IMP climbed to about 4 psi over the next 110 minutes, at which time the test was stopped.

In another test, the mixed liquor had a temperature of 18.0° C. and flux was held constant at 38 gfd. The system was run for 30 minutes to establish a baseline TMP increase per cycle without FEC addition. The FEC was dosed at 1.2 mg/g MLSS for 72 minutes, which caused the TMP to immediately drop by 0.3 psi and become steady over time. A total of 3.2 mg of FEC had been added per gram of MLSS in the system. After the end of the dosing interval, the TMP rose but did not reach the baseline TMP increase per cycle for another 430 minutes.

In the examples above, the total amounts of FEC used were about 430 to 480 g. In comparison, adding FEC to the system as a whole to a concentration of 200 to 800 ppm would have required about 3000 to 12,000 g of FEC. Considering a larger plant, a 1 MGD MBR with a design temperature of 10° C. may have a total mixed liquor volume of about 1500 cubic meters, an MLSS concentration of 10 g/L, and a flow to the membrane tank of 5 MGD. Adding an FEC to a concentration of 200 to 800 ppm would require 300 to 1200 kg of FEC. In contrast, adding FEC at an instantaneous average dosage of 0.5 to 5 mg/g MLSS for a dosing time of 2 hours to control a high fouling condition lasting 4 to 16 hours would use only 8 to 80 kg of FEC.

The method of using FEC described above is useful for handling unexpected periods of short duration when sludge filterability would otherwise be reduced. The method may be also added as a retrofit to operating MBRs that are experiencing occasional periods of unstable operation. However, the method may also be used for anticipated short events such as an expected peak hour, maximum daily flux, or expected lowest temperature day in a municipal wastewater treatment plant. The FEC can be relied on to provide an increase in filterability during those times, for example by 20%. By increasing filterability during these periods of time, the required membrane surface area can be calculated based on less challenging conditions. This would allow for a reduced membrane surface area and capital cost for the design.

The description above provides one or more examples of a process and apparatus but does not limit or define the invention. Other processes and apparatus may also be within the scope of one or more of the following claims.

What is claimed is:

1. A process for treating wastewater in an MBR comprising a process tank and a membrane tank, the process comprising mixing a flux enhancing chemical into mixed liquor flowing from the process tank to the membrane tank.

2. The process of claim 1 wherein the flux enhancing chemical is added at a rate of between 0.05 and 10 mg per gram of mixed liquor suspended solids flowing from the process tank to the membrane tank.

3. The process of claim 1 wherein the flux enhancing chemical is mixed into the mixed liquor for a continuous dosing period of between 30 minutes and 8 hours.

4. The process of claim 3 wherein, after the dosing period of claim 3, flux enhancing chemical is not added to the MBR for at least 2 hours.

5. The process of claim 3 wherein the dosing period is started when one or more of the flow rate of the mixed liquor, the temperature of the mixed liquor, the dissolved oxygen content of the mixed liquor, the TMP applied to membranes in the membrane tank, a rate of change in the TMP applied to membranes in the membrane tank, the filterability of the mixed liquor, and the cake plus pose blocking resistance accumulate over a permeation cycle exceeds a predetermined limit.

6. The process of claim 3 wherein, after the dosing period is started, the rate of flux enhancing chemical addition is increased until one or more of the membrane TMP or resistance increase in a cycle and the TMP or resistance increase over a selected period of time, are below a pre-determined set point.

7. The process of claim 1 wherein the flux enhancing chemical comprises a tannin containing polymer.

8. An apparatus for treating wastewater comprising,
a process tank;
a membrane tank containing filtering membranes;
a channel for mixed liquor to flow from the process tank to the membrane tank;
a supply of a flux enhancing chemical in communication with the channel; and,
a mixer for mixing the flux enhancing chemical into mixed liquor flowing in the channel.

9. The apparatus of claim 8 having a controller connected to the supply of flux enhancing chemical and to one or more sensors in the channel or the membrane tank.
